(19) United States
(12) Patent Application Publication
(10) Pub. No.: US 2015/0286679 A1
(43) Pub. Date: Oct. 8, 2015

(54) EXECUTING A QUERY HAVING MULTIPLE SET OPERATORS

(71) Applicant: HEWLETT-PACKARD DEVELOPMENT COMPANY, L.P., Houston, TX (US)

(72) Inventors: Jaimin Mukesh Dave, Burlington, MA (US); Matthew Steven Fuller, Medfield, MA (US); Sreenath Bodagala, Cambridge, MA (US)

(21) Appl. No.: 14/437,363

(22) PCT Filed: Oct. 31, 2012
(86) PCT No.: PCT/US12/62750

§ 371 Date: Apr. 21, 2015

(51) Int. Cl. G06F 17/30

(52) U.S. Cl. CPC G06F 17/30454; G06F 17/30463; G06F 17/30339

(57) ABSTRACT

According to an example, a method for executing a query having multiple set operators includes adding an additional column that associates an identifier of the result table with data contained in the input result table in each input result table of an input query. The method also includes performing a Union All operation on the data contained in the input result tables to generate an intermediate result set, performing a Group By operation on the data contained in the intermediate result set to generate a grouped result set, wherein the Group By operation operates on various groups of rows and returns one row per each of the various groups, adding aggregation columns in the grouped result set containing counts of a number of times that each tuple exists in each of the input result tables, and applying a predicate on the grouped result set to execute the query.

### BACKGROUND

A relational database management system (RDBMS) stores data in tables, in which the tables are a collection of rows all having the same columns. Each of the columns in the tables maintains a particular type of data for the data that comprise the rows. The Structured Query Language (SQL) is often used to query, access, and manipulate the data contained in the tables. The SQL language includes the set operators Union, Union All, Intersect, Intersect All, Except, and Except All. Complex SQL queries use various combinations of the set operators Union, Intersect, and Except.

### BRIEF DESCRIPTION OF THE DRAWINGS

Features of the present disclosure are illustrated by way of example and not limited in the following figure(s), in which like numerals indicate like elements, in which:

FIG. 1 shows a functional block diagram of a computing environment, in which a database manager disclosed herein may be implemented, according to an example of the present disclosure;

FIG. 2 a functional block diagram of the machine illustrated in FIG. 1, according to an example of the present disclosure;

FIG. 3 shows a flow diagram of a method for executing a query, according to examples of the present disclosure;

FIGS. 4A-4D, respectively, depict diagrams of illustrating examples of various operations performed during the method depicted in FIG. 3, according to examples of the present disclosure;

FIG. 5 depicts a flow diagram of a method for generating a predicate, according to an example of the present disclosure;

FIG. 6 shows a diagram of a set operator parse tree upon which the method depicted in FIG. 5 may be implemented, according to an example of the present disclosure; and

FIG. 7 illustrates a schematic representation of a computing device, which may be employed to perform various functions of the machine depicted in FIGS. 1 and 2, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

As used throughout the present disclosure, the term “includes” means includes but not limited to, the term “including” means including but not limited to. The term “based on” means based at least in part on. In addition, the terms “a” and “an” are intended to denote at least one of a particular element.

Disclosed herein are example methods for executing a query having multiple set operators, in which the query may include a mix of set operators. Also disclosed herein are example apparatuses for implementing the example methods and example non-transitory computer readable mediums on which are stored machine readable instructions that implement the example methods. According to an example, the method for executing the query is implemented or invoked in a Vertica™ column-stored database.

An example method for executing a query disclosed herein comprises a set of operations that efficiently eliminate duplicates for set operators without requiring that multiple Group By operations be performed in determining an output to the query. In other words, through implementation of the method disclosed herein, the result to a query may be determined through creation of at most one hash table through a single Group By operation regardless of the number or type of set operators included in the query. By way of example, a Group By operation operates on various groups of rows and returns one row per each of the various groups, for instance, to eliminate duplicate rows from a result table. The set operators include Union, Intersect, and Except.

An example method disclosed herein may, however, also be extended to implement Intersect All and Except All without requiring significant changes to the method. Particularly, the example method may merely be changed to include a change in the number of times each tuple is shown in an output. By way of particular example, in the query select * from TableA Intersect All select * from TableB, the predicate will be the same as the Intersect query, i.e., count(A)>0 AND count(B)>0. However, each tuple that satisfies the above condition has to be outputted min(count(a), count(B)) times. All of the remaining operations will remain the same. In an example in which the set operator is Except All, the predicate will be the same as that of Except, but each tuple that satisfies the above condition has to be outputted max(count(a)−count(B),0) times.

In contrast, a conventional technique for executing a query containing a group of set operators is to perform a Join operation, which only accepts two inputs at a time. In this conventional technique, for n different set operators, n−1 hash tables are required to be built, which may not be possible when the memory into which the hash tables are being built is too small for any of the n−1 hash tables to be stored at a given time. As such, the query may perform poorly if a hash table has to be written to disk multiple times because of insufficient memory to hold any of the hash tables. In addition, this conventional technique depends upon the use of the cost model to select the inner and outer tables. Thus, if the cost model incorrectly selects the inner and outer tables, the resulting Join operation may result in a relatively large hash table, which results in a relatively large consumption of memory resources. The relatively large hash table resulting from this conventional technique may also result in poor performance, for instance, in the case of the Except operator because in case of Except, the hash table may only be created from the right input as a result, if the size of the right input is very large as compared with the left input then the query may perform poorly. Another possible disadvantage of this conventional technique is that in order to eliminate a duplicate input, another hash table is required to be built for a Group By operation apart from the one that was built during the Join operation.

Another conventional technique comprises a technique implemented by Postgres. Under this conventional technique, only two inputs are allowed per operation and thus, a query involving N set operators may require building of N−1 hash tables to determine the output. This technique is bound by the precedence of the set operator query. For queries involving multiple set operators, this conventional technique applies multiple Group By operations, which may be costly. Furthermore, this conventional technique depends on the cost model for selecting the inner and outer tables in the case of Intersect and always selects the left table in the case of Except.

In comparison with conventional query processing techniques, therefore, aspects of the present disclosure enable the result to the query to be determined in a relatively efficient manner and without reliance upon a relatively large memory.

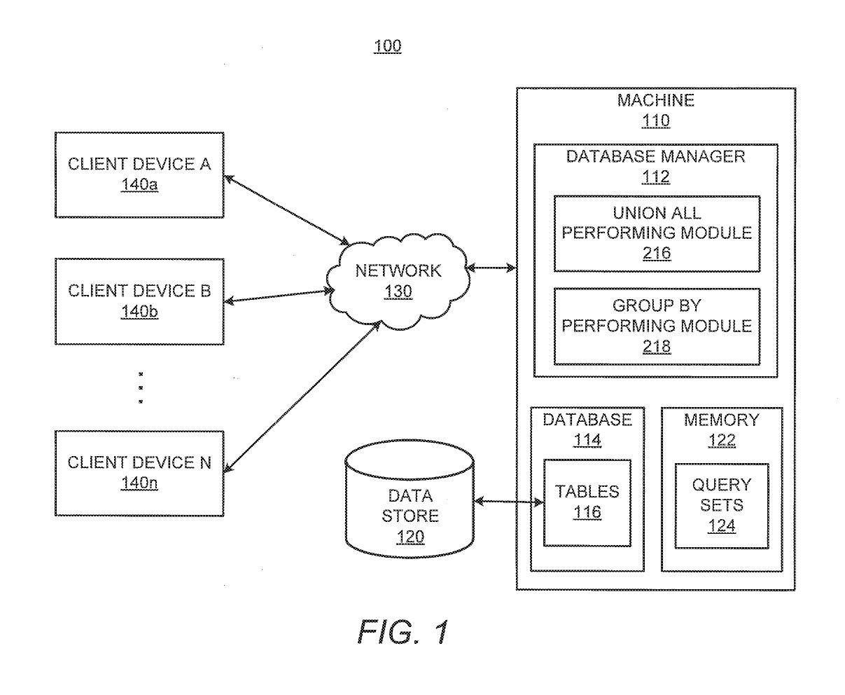

With reference first to FIG. 1, there is shown a functional block diagram of a computing environment 100, in which a database manager disclosed herein may be implemented, according to an example. It should be readily apparent that the diagram depicted in FIG. 1 represents a generalized illustration and that other components may be added or existing components may be removed, modified or rearranged without departing from a scope of the present disclosure.

The computing environment 100 is depicted as including a machine 110, a data store 120, a network 130, and a plurality of client devices 140a-140n, in which “n” represents an integer greater than or equal to one. The machine 110, which may comprise a computer, a server, etc., is also depicted as including a database manager 112, a database 114 containing tables 116, and a memory 122 containing query sets 124. The database manager 112 is to manage the database 114, for instance, access and modify data contained in the tables 116 of database 114, execute queries on the data contained in the tables 116, etc. For instance, the database manager 112 is to execute SQL operations involving Union, Intersect, Except, Union All, Intersect All, and Except All set operators. As also shown in FIG. 1, the database manager 112 includes a Union All performing module 216 and a Group By performing module 218, which may perform various functions in executing SQL operations as discussed in detail below. Additionally, the query sets 124, which may comprise, for instance, intermediate result sets, grouped result sets, etc., of a query operation may be stored in the memory 122, which may comprise a random access memory, such as dynamic random-access memory (DRAM). In this regard the query sets 124 may be stored in the memory 122 instead of on a disk, such as the data store 120. In one regard, therefore, the query sets 124 may not be written to disk multiple times, but instead, may be stored and accessed in the memory 122. Various manners in which the database manager 112 may be implemented are described in greater detail below.

The actual data for the tables 116 may be stored in the data store 120, which comprises volatile and/or non-volatile memory, such as an optical or magnetic media on a hard disk, DRAM, EEPROM, MRAM, phase change RAM (PCRAM), Memristor, flash memory, or the like. Additional tables, for instance, those resulting from set operators, such as Union, Intersect, Except, etc., may also be stored in the data store 120. According to an example, the database 114 comprises a Vertica™ column-stored database. In addition, although the data store 120 has been depicted as being separate from the machine 110, the data store 120 may be integrated with the machine 110 without departing from a scope of the disclosure contained herein.

According to an example, the machine 110 is to receive queries for information contained in the data store 120 from the client devices 140a-140n and to communicate results of query operations to the client devices 140a-140n over the network 130. The client devices 140a-140n comprise one or more of desktop computers, laptop computers, tablet computers, personal digital assistants, smartphones, cellular telephones, etc. In addition, the network 130 comprises an IP network, such as the Internet, a cellular network, a local area network, a wide area network, etc. In addition, or alternatively, queries may be inputted directly through the machine 110.

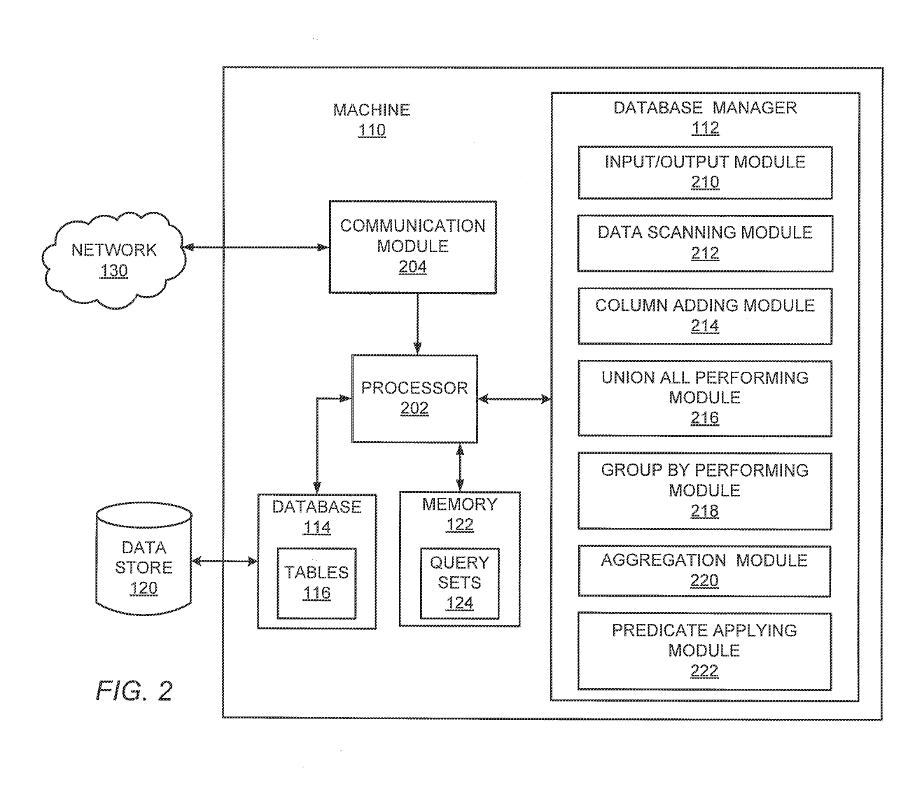

Turning now to FIG. 2, there is shown a functional block diagram of the machine 110 illustrated in FIG. 1, according to an example. It should be understood that the machine 110 may include additional components and that some of the components described herein may be removed and/or modified without departing from a scope of the machine 110 disclosed herein.

The machine 110 is depicted as including all of the same components as those in the machine 110 depicted in FIG. 1. The machine 110 and the database manager 112 in FIG. 2 are also depicted as including additional components. Particularly, the machine 110 is depicted as also including a processor 202 and a communication module 204. The processor 202 comprises a microprocessor, a micro-controller, an application specific integrated circuit (ASIC), or the like, and is to perform various processing functions in the machine 110. For instance, the processor 202 is to implement the database manager 112 and the communication module 204 and to access the database 114. The processor 202 is also to store and access query sets 124 in the memory 122. The communication module 114 comprises a hardware device, machine readable instructions, or a combination thereof to enable the machine 110 to receive and send data over the network 130.

The database manager 112 is depicted as including an input/output module 210, a data scanning module 212, a column adding module 214, a Union All operation performing module 216, A Group By operation performing module 218, an aggregation module 220, and a predicate applying module 222. The processor 202 is to invoke or implement the modules 210-222 in performing various operations as discussed in greater detail herein below.

According to an example, the database manager 112 comprises machine readable instructions stored, for instance, in a volatile or non-volatile memory, such as DRAM, EEPROM, MRAM, flash memory, floppy disk, a CD-ROM, a DVD-ROM, or other optical or magnetic media, and the like. In this example, the modules 210-222 comprise modules of machine readable instructions stored in the memory, which are executable by the processor 202. According to another example, the database manager 112 comprises a hardware device, such as a circuit or multiple circuits arranged on a board. In this example, the modules 210-222 comprise circuit components or individual circuits, which the processor 202 is to control. According to a further example, the database manager 112 comprises a combination of modules with machine readable instructions and hardware modules.

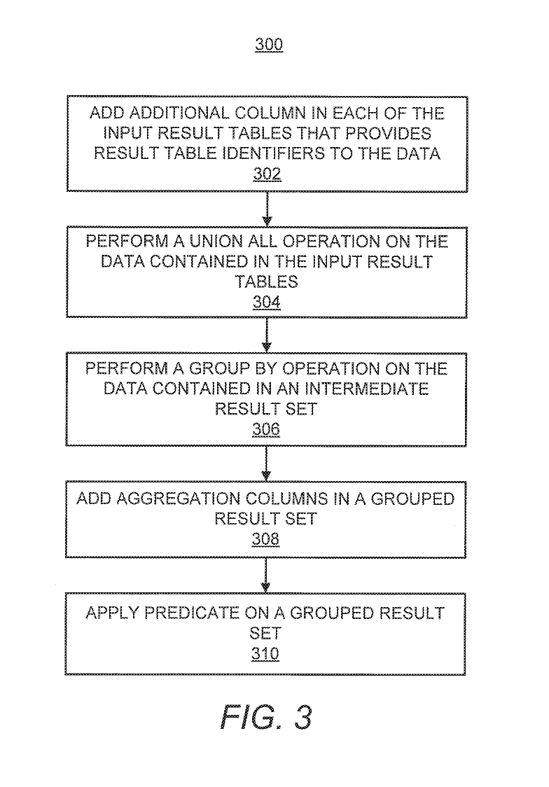

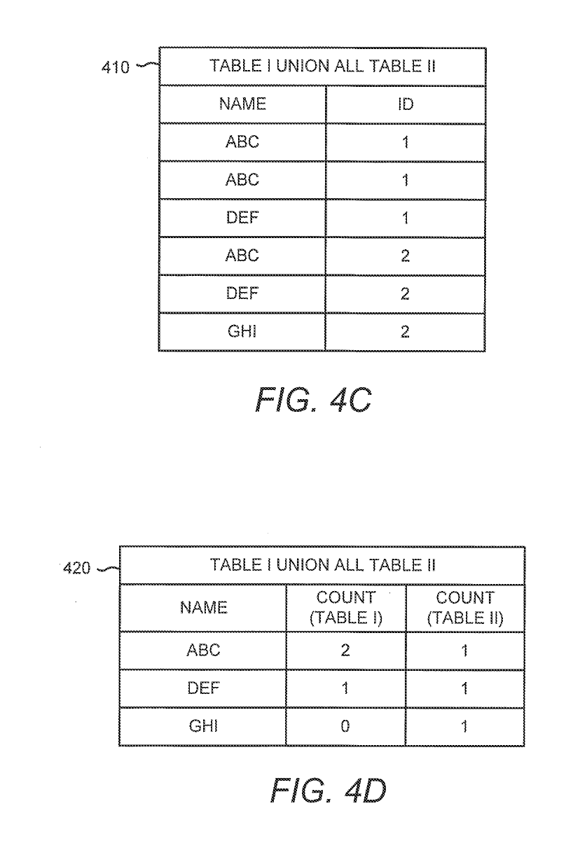

Various manners in which the modules 210-222 of the database manager 112 may operate are discussed with respect to the methods 300 and 500 respectively depicted in FIGS. 3 and 5. It should be readily apparent that the methods 300 and 500 represent generalized illustrations and that other elements may be added or existing elements may be removed, modified or rearranged without departing from the scopes of the methods 300 and 500.

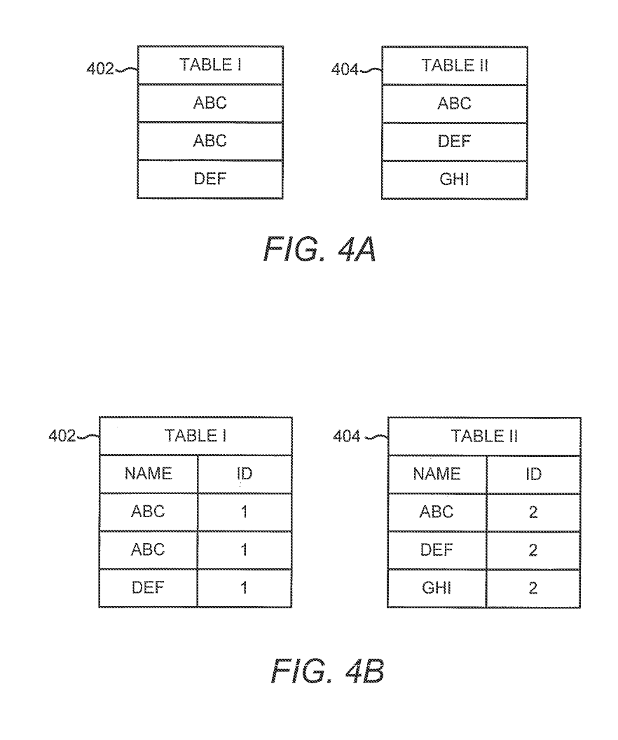

With reference first to FIG. 3, there is shown a flow diagram of a method 300 for executing a query, according to an example. The operations performed in the method 300 are described with respect to the examples provided in FIGS. 4A-4D for purposes of illustration only and the examples provided in FIGS. 4A-4D are therefore not to be construed as limiting features of the present disclosure in any respect.

According to an example, prior to implementation of the method 300, an input query may be received, for instance, by the input/output module 210. For example, the input/output module 210 receives an input query communicated over the network 130 by a client device 140a. The input query may be transformed to identify the set operators to be applied to a plurality of tables 116 in order to determine an output to the query. In some instances, the transformation of the input query results in a query requiring a mix of set operators to be applied on the plurality of tables. The set operators comprise, for instance, Union, Intersect, and Except. As discussed in greater detail below with respect to FIG. 5, the input query may be transformed into a set operator parse tree, from which a predicate may be generated.

The Union operator produces a result set that combines the tuples of two input result tables (also referred to as relations) of an input query, such that each of the tuples in a result set is in either or both input result tables. The result set may comprise a result of a query on the input result tables and may also comprise a table or a relation. The result set may also be stored on the memory 122 instead of the data store 120, as shown in FIG. 2. The Union operator will also remove duplicates from the result set while the Union All operator will preserve duplicates. The Intersect operator takes the tuples of the left and right result tables and outputs a result set, in which each tuple belongs to both input result tables. The Intersect operator removes duplicate tuples from the input result tables. Under operation of the Intersect All operator, a row that has m duplicates in the left result table and n duplicates in the right result table will appear min(m,n) times in the input result table. The Except operator produces a result set having all of the rows that are in a first result table but not a second result table. In other words, the Except operator takes the distinct tuples of one query and returns the tuples that do not appear in a second result table. The Except All operator will not remove duplicates. With Except ALL, a row that has m duplicates in the left result table and n duplicates in the right result table will appear as max(m−n,0) times in the result set.

In addition, the data contained in a plurality of result tables 116 of an input query are scanned, for instance, by the data scanning module 212. The result tables 116 may be scanned to determine which of the result tables 116 contain data that is relevant to the received input query. In addition, the result tables 116 may be scanned to determine the data contained in the result tables 116. By way of particular example, and with reference to FIG. 4A, two result tables, Table I 402 and Table II 404 are scanned by the data scanning module 212 to determine that Table I contains data having names of “ABC”, “ABC”, and “DEF”, and that Table II 404 contains data having names of “ABC”, “DEE”, and “GHI”. These tables 402 and 404 will be used by way of example in describing some of the operations performed in the method 300.

At block 302, an additional column is added in each input result table of an input query, for instance, by the column adding module 214. The additional column includes an identifier of the input result table in which the data is contained to thus enable identification of the input result table from which particular data has been extracted. The results of a query performed on the tables 116 contained in the database 114, i.e., the input result tables, and the additional columns may be stored in the memory 122. By way of example, as shown in FIG. 4B, an additional column is added to each of the input result tables 402 and 404 and the identifier assigned to one of the input result tables 402 differs from the identifier assigned to another one of the input result tables 404. In the example depicted in FIG. 4B, Table I 402 has a result table identifier “1” and Table II 404 has a result table identifier “2” and the tables 402 and 404 may be stored in the memory 122.

At block 304, a Union All operation is performed on the data contained in the input result tables to generate an intermediate result set 410 (FIG. 40), for instance, by the Union All operation performing module 216. According to an example, the intermediate result set differs from the input result tables 402 and 404 in that the input result tables 402 and 404 are physically stored on a disk, e.g., the data store 120, whereas the intermediate result set 410 is stored in the memory 122. As discussed above, performance of the Union All operation combines the tuples of two tables, such that each of the tuples in the intermediate result set 410 (FIG. 40) is in either or both of the input result tables, while preserving duplicates in both tables. FIG. 40 shows an example in which a Union All operation is performed on the Tables 402 and 404 depicted in FIG. 4B, As shown in FIG. 40, the Union All operation results in an intermediate result table labeled “Table I Union All Table II” that includes the tuples from Table I 402 and the tuples from Table II 404, along with their respective identifiers.

At block 306, a Group By operation is performed on the data contained in the intermediate result set, for instance, by the Group By operation performing module 218. Generally speaking, the Group By operation operates on various groups of rows and returns one row per each of the various groups, for instance, to eliminate duplicate rows from a result table. By way of example, the Group By operation returns one value for one group of rows and another value for another group of rows. FIG. 4D shows an example in which a Group By operation is performed on the intermediate result table 410 shown in FIG. 40. As shown in FIG. 4D, the rows in the grouped result table 420 have been grouped according to the names of the data contained in the rows and duplicate rows have been eliminated.

At block 308, aggregation columns containing counts of the number of times that each tuple exists in each of the plurality of input result tables are added in the grouped result set, for instance, by the aggregation module 220. That is, the aggregation columns are added to the grouped result set to identify the count of the tuples existing in each of the input result tables. According to an example, the count of the tuples existing in each of the input result tables may be determined from the identifiers listed in the intermediate result set 410. The grouped result set may comprise a table or a relation and may be stored in the memory 122. FIG. 4D also shows an example of the addition of the aggregation columns in a grouped result set 420. As shown in FIG. 40, in the grouped result set 420, the rows have been grouped according to the names of the data contained in the rows and the counts of the data names existing in each of the result Tables I and II 402 and 404 have been added into the aggregation columns.

At block 310, a predicate is applied on the grouped result set to execute the query, for instance, by the predicate applying module 222. The predicate may be generated through implementation of an operation that is performed to generate the predicate, which is discussed in greater detail herein below. Generally speaking, however, the predicate may be included in a Having clause and is used to filter rows resulting from the Group By clause. By way of particular example, and with reference to FIG. 4D, a predicate may generated that requires the count of the tuples existing in both Table I and Table II be greater than zero. In this example, the output to the predicate is “ABC” and “DEF”, while “GHI” is not considered to fall within the predicate, and thus is not outputted as part of the query result.

Although the method 300 may end following performance of block 310, the results of the executed query may also be communicated to the client device 140a that requested the query to be performed, for instance, by the input/output module 210.

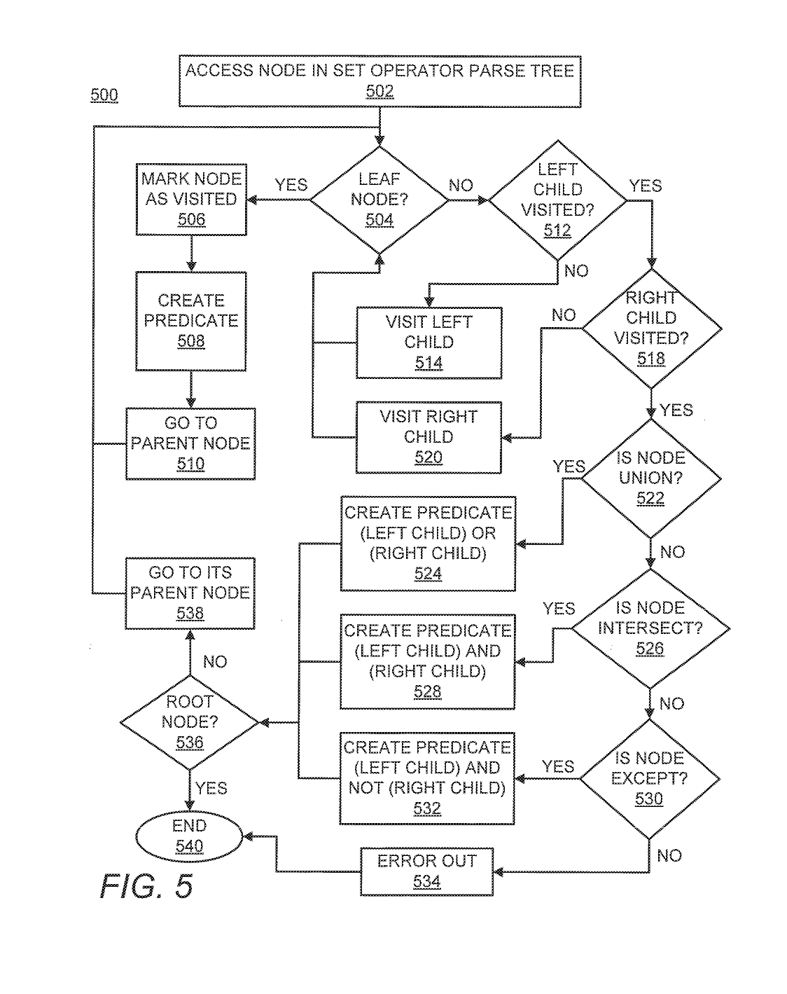

Turning now to FIG. 5, there is shown a flow diagram of a method 500 for generating a predicate, according to an example. The predicate applying module 222 or a separate module may implement the method 500. In any regard, the method 500 may be implemented on each of the nodes in a set operator parse tree, which may comprise a transformation of a query into a plurality of set operators, for instance, as shown in the diagram 600 in FIG. 6. It should be clearly understood that references to the set operator parse tree 600 in FIG. 6 are made for purposes of illustration and by way of example only and are therefore not to be construed as limiting features of the present disclosure in any respect.

Generally speaking, implementation of the method 500 results in generation of a predicate to be applied on the grouped result set discussed above with respect to block 310 in FIG. 3. In addition, the predicate is generated from a set operator parse tree containing a parent node and a plurality of leaf nodes that define respective queries. Particularly, a plurality of predicates corresponding to the queries contained in the leaf nodes are created and the Predicate that corresponds to the plurality of predicates is created according to a type of the parent node of the leaf nodes. That is, if the parent node is of the type “Union,” the Predicate is generated to include the left child node's predicate or the right child node's predicate; if the parent node is of the type “Intersect,” the predicate is generated to include the left child node's predicate and the right child node's predicate; and if the parent node is of the type “Except,” the predicate is generated to include the left child node's predicate and not the right child node's predicate. The description of the method 500 describes these features in greater detail.

At block 502, a current node in a set operator parse tree is accessed as an input. By way of example, the current node being accessed may comprise the root node labeled “Union”, the node labeled “Intersect”, or the node labeled “Except” in FIG. 6. According to a particular example, the current node accessed at block 502 comprises a leaf node.

At block 504, a determination is made as to whether the current node being accessed in the set operator parse tree is a leaf node. That is, a determination is made as to whether the current node has a child node. If the current node is a leaf node, i.e., contains no child nodes, the current node is marked as having been visited, as indicated at block 506. In addition, at block 508, a predicate having a count (A)>0 is created, where A is the column containing the counter for each tuple. (e.g., the aggregation column). In other words, a predicate is created out of the query defined in the current node, in which the count of the query is greater than zero. Following creation of the predicate for the current node at block 508, the parent node of the current node is visited as indicated at block 510. By way of example in which the current node comprises the node “Query1” in FIG. 6, the parent node visited at block 510 comprises the node “Intersect.”

In addition, a determination is made as to whether the parent node comprises a leaf node at block 504. In response to a determination that the parent node is not a leaf node, a determination is made as to whether the left child node of the parent node has been visited, as indicated at block 512. In response to a determination that the left child node has not been visited, at block 514, the left child node is visited. In addition, blocks 504-514 are repeated until a predicate for a left child leaf node is created at block 508. By way of example with respect to the diagram 600 in FIG. 6, in which the parent node is the “Intersect” node, the left child node is the “Query1” node and a predicate for that node is created at block 508.

Following creation of the predicate for the left child node, the parent node is again accessed at block 510 and blocks 504 and 512 are repeated. In response to a determination that the left child node has been visited at block 512, a determination is made as to whether the right child node of the parent node has been visited at block 518. In response to a determination that the right child node has not been visited, at block 514, the right child node is visited. In addition, blocks 504-518 are repeated until a predicate for a right child leaf node is created at block 508. By way of example with respect to the diagram 600 in FIG. 6, in which the parent node is the “Intersect” node, the right child node is the “Query2” node and a predicate for that node is created at block 508.

Following access back to the parent node at block 510, and determinations that the left and right child nodes have been visited at blocks 512 and 518, a predicate for the parent node may be created depending upon the type of the parent node. Although the following operations have been depicted as occurring in a particular order, it should clearly be understood that the following operations may be performed in any order without departing from a scope of the present disclosure.

At block 522, a determination may be made as to whether the parent node (i.e., the currently accessed node) is of the type “Union”. In response to a determination that the parent node is of the type “Union”, at block 524, a predicate is created that includes the left child node's predicate OR the right child node's predicate. However, in response to a determination that the parent node is not of the type “Union,” a determination is made as to whether the parent node is of the type “Intersect” at block 526. In response to a determination that the parent node is of the type “Intersect”, at block 528, a predicate is created that includes the left child node's predicate AND the right child node's predicate. However, in response to a determination that the parent node is not of the type “Intersect,” a determination is made as to whether the parent node is of the type “Except” at block 530. In response to a determination that the parent node is of the type “Except”, at block 532, a predicate is created that includes the left child node's predicate AND NOT the right child node's predicate. However, in response to a determination that the parent node is not of the type “Except,” an error out message is reported at block 534. An error out message may be reported, for instance, because an error condition exists if the parent node does not comprise one of the types of nodes discussed above.

Following any of the blocks 524, 528, and 532, a determination is made as to whether the current node comprises a root node of the set operator parse tree at block 536. In response to a determination that the currently accessed node does not comprise a root node, the parent node of the current node is visited at block 538. In addition, blocks 504-538 may be repeated on the parent node. In response to a determination that the current node is a root node, i.e., does not have a parent node, and/or if the error out condition is reached at block 534, the method 500 may end as indicated at block 540.

Following implementation of the method 500 on the leaf nodes and the non-leaf nodes of the set operator parse tree, a number of predicates may have been created at blocks 524, 528, and 532. In this regard, the predicates may be combined according to a higher level parent node, in which the predicates created at blocks 524, 528, and 532 become the predicates of the left and right child nodes of the parent nodes in further iterations of the method 500. Thus, the final predicate is one that is created according to the type of the root node. By way of example with respect to the diagram 600 in FIG. 6, implementation of the method 500 on that diagram results in the following predicate:

(count(Query1)>0 AND count (Query2)>0) OR (count(Query3)>0 AND NOT (count(Query4)>0), in which count(QueryN) indicates the number of times the tuple occurs in an output for QueryN.

Some or all of the operations set forth in the methods 300 and 500 may be contained as utilities, program, or subprograms, in any desired computer accessible medium. In addition, the methods 300 and 500 may be embodied by or stored as machine readable instructions, which may exist in a variety of forms both active and inactive. For example, they may exist as source code, object code, executable code or other formats. Any of the above may be embodied or stored on a non-transitory computer readable storage medium. Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

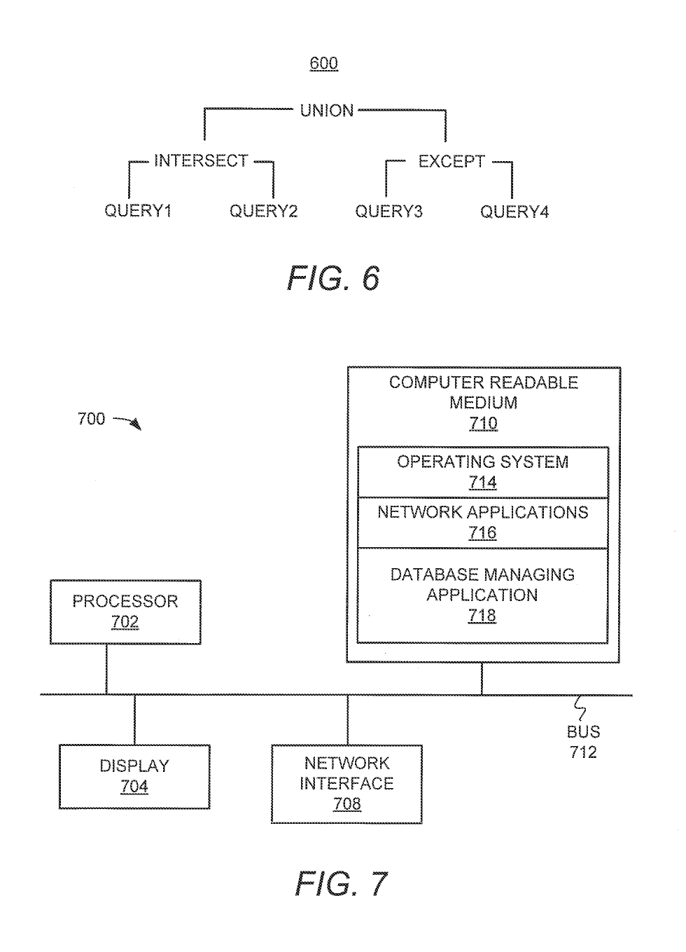

Turning now to FIG. 7, there is shown a schematic representation of a computing device 700, which may be employed to perform various functions of the machine 110 depicted in FIGS. 1 and 2, according to an example. The computing device 700 includes a processor 702, such as but not limited to a central processing unit; a display device 704, such as but not limited to a monitor; a network interface 708, such as but not limited to a Local Area Network LAN, a wireless 802.11 LAN, a 3G/4G mobile WAN or a WiMax WAN; and a computer-readable medium 710. Each of these components is operatively coupled to a bus 712. For example; the bus 712 may be an EISA, a PCI, a USB, a FireWire, a NuBus, or a PDS.

The computer readable medium 710 comprises any suitable medium that participates in providing instructions to the processor 702 for execution. For example, the computer readable medium 710 may be non-volatile media, such as memory. The computer-readable medium 710 may also store an operating system 714, such as but not limited to Mac OS, MS Windows, Unix, or Linux; network applications 716; and a database managing application 718. The operating system 714 may be multi-user, multiprocessing, multitasking, multithreading, real-time and the like. The operating system 714 may also perform basic tasks, such as but not limited to recognizing input from input devices, such as but not limited to a keyboard or a keypad; sending output to the display 704; keeping track of files and directories on medium 710; controlling peripheral devices, such as but not limited to disk drives, printers, image capture device; and managing traffic on the bus 712. The network applications 716 include various components for establishing and maintaining network connections, such as but not limited to machine readable instructions for implementing communication protocols including TCP/IP, HTTP, Ethernet, USB, and FireWire.

The database managing application 718 provides various components for executing a query as discussed above with respect to the methods 300 and 500 in FIGS. 3 and 5. The database managing application 718 may thus comprise the input/output module 210, the data scanning module 212, the column adding module 214, the Union All operation performing module 216, the Group By operation performing module 218, the aggregation module 220, and the predicate applying module 222. In this regard, the database managing application 718 may include modules for performing the methods 300 and 500.

In certain examples, some or all of the processes performed by the application 718 may be integrated into the operating system 714. In certain examples, the processes may be at least partially implemented in digital electronic circuitry, or in computer hardware, machine readable instructions (including firmware and software), or in any combination thereof, as also discussed above.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method for executing a query having multiple set operators, said method comprising:
adding an additional column in each of a plurality of input result tables of an input query, wherein the additional column associates an identifier of the input result table with data contained in the input result table;
performing a Union All operation on the data contained in the plurality of input result tables to generate an intermediate result set;
performing a Group By operation on the data contained in the intermediate result set to generate a grouped result set, wherein the Group By operation operates on various groups of rows and returns one row per each of the various groups;
adding aggregation columns in the grouped result set containing counts of a number of times that each tuple exists in each of the plurality of input result tables; and
applying a predicate on the grouped result set to execute the query.

2. The method according to claim 1, further comprising:
scanning the data contained in the plurality of input result tables prior to adding the additional column in each of the plurality of input result tables.

3. The method according to claim 1, wherein performing the Group By operation further comprises performing a single Group By operation for a combination of the multiple set operators.

4. The method according to claim 1, wherein the multiple set operators comprise at least one of Union, Intersect, and Except.

5. The method according to claim 1, wherein adding aggregation columns further comprises adding a number of aggregation columns that is equal to the number of the plurality of input result tables.

6. The method according to claim 1, further comprising:
generating the predicate from a set operator parse tree containing a plurality of non-leaf nodes that define any of the set operators and a plurality of leaf nodes that define respective queries, wherein generating the predicate comprises:
creating respective predicates corresponding to the queries; and
creating the predicate corresponding to the respective predicates according to a type of the parent node.

7. The method according to claim 6, further comprising:
creating a plurality of sets of predicates for respective sets of leaf nodes; and
creating the predicate to include combinations of the plurality of sets of predicates according to types of parent nodes of the respective sets of leaf nodes.

8. A database manager to execute a query having multiple set operators, said database manager comprising:
a memory storing a set of machine readable instructions to:
receive a request for a query containing multiple set operators;
add an additional column in each of a plurality of input result relations of an input query, wherein the additional column associates an identifier of the input result relation with data contained in the input result relation;
perform a Union All operation on the data contained in the plurality of input result relations to generate an intermediate result relation;
perform a Group By operation on the data contained in the intermediate result relation to generate a grouped result relation, wherein the Group By operation operates on various groups of rows and returns one row per each of the various groups;
add aggregation columns in the grouped result relation containing counts of a number of times that each tuple exists in each of the plurality of input result relations; and
apply a predicate on the grouped result relation to execute the query; and
a processor to implement the machine readable instructions.

9. The database manager according to claim 8, wherein the machine readable instructions are further to:
scan the data contained in the plurality of result relations prior to the additional column in each of the plurality of input relations being added.

10. The database manager according to claim 8, wherein the machine readable instructions are to perform a single Group By operation for a combination of the mix of set operators.

11. The database manager according to claim 8, wherein the set of operators comprises at least one of Union, Intersect, and Except.

12. The database manager according to claim 8, wherein the machine readable instructions are further to:
generate the predicate from a set operator parse tree containing a parent node and a plurality of leaf nodes that define respective queries.

13. The database manager according to claim 12, wherein the predicate is generated through creation of respective predicates corresponding to the queries and creation of the predicate corresponding to the respective predicates according to a type of the parent node.

14. A non-transitory computer readable storage medium on which is stored machine readable instructions that when executed by a processor, implement a method for executing a query containing multiple set operators, said machine readable instructions comprising code to:
receive the query;
scan a plurality of input result tables of the query;
add an additional column in each of the plurality of input result tables, wherein the additional column associates an identifier of the input result table with data contained in the input result table;
perform a Union All operation on the data contained in the plurality of input result tables to generate an intermediate result set;
perform a Group By operation on the data contained in the intermediate result set to generate a grouped result set, wherein the Group By operation operates on various groups of rows and returns one row per each of the various groups;
add aggregation columns in the grouped result set containing counts of a number of times that each tuple exists in each of the plurality of input result tables; and
apply a predicate on the grouped result table to execute the query.

15. The non-transitory computer readable storage medium according to claim 14, said machine readable instructions further comprising code to:
perform a single Group By operation for a combination of the multiple set operators.
